(19) United States
(12) Patent Application Publication
(10) Pub. No.: US 2026/0048369 A1
(43) Pub. Date: Feb. 19, 2026

(54) ENHANCED WATER DISPENSING SYSTEM

(71) Applicants: Anthony Bold, Miami, FL (US); Ben Greenberg, Miami, FL (US)

(72) Inventors: Anthony Bold, Miami, FL (US); Ben Greenberg, Miami, FL (US)

(21) Appl. No.: 19/288,752

(22) Filed: Aug. 1, 2025

Related U.S. Application Data
(60) Provisional application No. 63/678,960, filed on Aug. 2, 2024.

(51) Int. Cl. B01F 35/22; A23L 2/52; B01F 23/43; B01F 23/53; B01F 23/70; B01F 35/32; B01F 35/71; B01F 35/90; B01F 101/14; C02F 1/00; C02F 1/28; C02F 1/32; C02F 1/42; C02F 1/68; C02F 9/00

(52) U.S. Cl. CPC B01F 35/2205; A23L 2/52; B01F 23/43; B01F 23/53; B01F 23/708; B01F 23/712; B01F 35/3204; B01F 35/714112; B01F 35/717611; B01F 35/90; C02F 1/008; C02F 9/00; B01F 2035/98; B01F 2035/99; B01F 2101/14; C02F 1/003; C02F 1/283; C02F 1/325; C02F 1/42; C02F 1/686; C02F 1/687; C02F 2209/008; C02F 2209/02; C02F 2209/03; C02F 2209/40; C02F 2209/42; C02F 2301/08; C02F 2303/04

(57) ABSTRACT

A hydration system is provided for preparing customized beverages from a municipal water source. The system includes a housing configured for wall-mounted or freestanding installation, a multistage purification assembly, a mixing chamber, additive delivery subsystems, and a temperature regulation module. Additives may be dispensed from liquid reservoirs or a powder dispensing assembly and mixed with purified water in a vortex mixer. A control unit regulates flow paths, additive dosing, temperature, and dispensing based on user input received via a touchless interface, NFC module, or wireless application. The system may incorporate UV-C sterilization, load cell volume verification, and automated cleaning cycles. Sensors throughout the system monitor fluid conditions and support responsive operation. Optional configurations support biometric identification, cloud connectivity, and data logging. The modular architecture permits deployment in residential, commercial, and public environments. Aesthetic enclosures may be adapted to blend with architectural surroundings while maintaining accessibility and hygiene compliance.

### CLAIM OF PRIORITY

This application claims the benefit of United States Provisional Patent Application 63/678,960 filed on Aug. 2, 2024, which is incorporated by reference herein in its entirety.

### BACKGROUND OF THE INVENTION

### Field of the Invention

The present invention relates generally to water treatment and beverage dispensing technologies. More specifically, the invention pertains to systems and methods for purifying municipal water, enhancing the purified water with selected nutrient and supplement compositions, and dispensing the resulting beverage through an integrated, compact, and modular platform that supports automated control, user interaction, and remote monitoring.

### DESCRIPTION OF THE RELATED ART

Consumers increasingly demand more sophisticated hydration options that not only provide clean drinking water, but also offer functional health benefits and enhanced user experiences. The contemporary landscape of water systems reflects this shift, as conventional approaches to water dispensing and enhancement are frequently seen as inadequate for modern expectations. Whether in commercial facilities, public installations, or residential settings, existing systems often fall short in delivering the level of personalization, performance, and integration required to meet both consumer preferences and operational standards.

In many buildings and public environments, water is dispensed through either traditional plumbing fixtures or standalone filtration appliances. These systems generally emphasize basic filtration and do not offer meaningful customization or any form of nutritional enhancement. Standard filtration units may remove certain particulates and improve taste, but they are not designed to alter or elevate the functional composition of the water being consumed. Moreover, such systems tend to be passive and lack any digital interface or intelligent control, resulting in a static experience that fails to adapt to the user or operating context.

Efforts to enhance water by introducing flavorings, vitamins, or electrolytes have emerged in various forms, ranging from personal water bottles with infusion chambers to large-scale beverage machines. However, these implementations are frequently rudimentary in design and unreliable in operation. For example, many rely on liquid concentrates or syrup-based injectors that require regular replenishment, are prone to microbial growth, and degrade in quality over time due to temperature fluctuations or contamination. Liquid additives also present challenges in preserving flavor integrity, shelf life, and nutritional potency, particularly in systems with shared storage tanks or open nozzles. Additionally, the logistics of stocking, storing, and distributing perishable liquid concentrates can create both cost and safety issues for operators.

Another common limitation is the inability to maintain hygienic operation in high-traffic environments. Many dispensing systems are designed with push buttons, manual levers, or touchscreen interfaces that require direct user contact. In shared or public settings, such touchpoints pose a risk of microbial transfer and reduce user confidence in system cleanliness. While some systems have integrated limited forms of touchless operation, such as foot pedals or infrared triggers, these solutions are often bolted-on adaptations rather than fully integrated design features. They typically lack the flexibility and adaptability to interface with mobile devices, user profiles, or digital identity platforms.

Temperature control represents an additional area of concern. Many water dispensing systems are capable of providing either chilled or ambient water, but not both. In instances where heating elements are provided to deliver warm water, the heating mechanisms are often inefficient or insufficiently isolated, resulting in inconsistent output or degradation of any dissolved additives. Systems that attempt to deliver precise thermal control typically do so at the cost of energy efficiency or mechanical complexity, often requiring larger form factors or extensive maintenance. These temperature limitations become particularly acute when multiple types of beverages—such as cold electrolyte-infused water or warm vitamin-enhanced blends—are desired from the same unit.

A further drawback arises in the dosing and mixing of additives, particularly powders. Systems that utilize powder formulations must overcome technical challenges such as moisture ingress, powder clumping, and dosing accuracy. Powder delivery mechanisms that rely on augers, vibratory feeders, or scoop-based designs often suffer from mechanical inconsistencies, cross-contamination, or dosage variability. Moreover, such mechanisms are typically not automated or synchronized with the water flow in real-time, resulting in uneven formulations, particularly during successive dispensing cycles. Powder-based additives have significant advantages in terms of stability and transportability, but they require precise handling systems to unlock their full potential.

Current systems also tend to operate as closed-loop devices with little or no remote visibility or diagnostic capacity. Operators must rely on manual inspection or routine service intervals to determine when to refill additive supplies, clean internal components, or address performance issues. This lack of real-time feedback contributes to increased labor costs and system downtime. Additionally, when problems do arise, the absence of telemetry or error reporting can make diagnosis difficult and time-consuming. The inability to perform remote updates, calibrations, or usage analytics represents a serious limitation in the context of scalable deployments, such as those needed in multi-unit commercial operations or public infrastructure rollouts.

In terms of infrastructure, water dispensing systems are typically designed either as countertop units for residential use or as freestanding machines for commercial use. These systems are often bulky, visually intrusive, and incompatible with built-in or flush-mounted installations. Many are not designed to interface cleanly with standard wall framing, plumbing conduits, or electrical lines. As a result, deploying such systems in public areas, office lobbies, wellness centers, or apartment complexes often requires significant customization. This increases installation complexity, raises construction costs, and limits the versatility of the system. Moreover, systems that are not designed for tamper-resistant mounting or serviceability present challenges in high-use or unattended environments.

Connectivity and user interaction also remain underdeveloped in many water systems. A growing number of consumers expect seamless interaction with devices through mobile apps, user profiles, or smart authentication. However, most hydration systems do not support these modern expectations. Some units may incorporate rudimentary interfaces or barcode readers, but few offer true integration with cloud infrastructure, mobile identity systems, or adaptive personalization. The inability to recall user-specific settings, health preferences, or consumption history severely limits the usefulness of such systems in wellness-focused environments, where nutritional tracking and behavioral reinforcement may be desired.

Security and data management pose yet another concern. As connected devices become more common in public and private infrastructure, the systems used to deliver hydration must also safeguard user data, system logs, and remote access pathways. Many existing platforms do not implement robust encryption protocols, redundant connectivity options, or authenticated firmware update mechanisms. This makes them vulnerable to data leakage, operational disruption, or software obsolescence. In enterprise or government settings, such shortcomings can render the deployment of water enhancement systems infeasible from a cybersecurity compliance perspective.

The scalability of current solutions is similarly constrained. Systems designed for a single-use case, such as office refreshment or home filtration, are often difficult to adapt to other applications without extensive redesign. This lack of modularity prevents operators from using a unified platform across diverse environments, which in turn complicates inventory management, technician training, and spare parts procurement. A system that could be implemented in various sizes and configurations—ranging from compact wall-mounted models to larger free-standing kiosks—would better meet the needs of real-world deployment scenarios.

Additionally, the sustainability profile of many current systems is suboptimal. Excessive reliance on disposable plastic bottles, inefficient thermal systems, or single-use additive pods undermines the environmental goals of both consumers and institutions. The carbon footprint of sourcing, transporting, and storing prepackaged beverage ingredients is substantial, and many existing systems do not integrate renewable energy features, such as solar power compatibility. In an era of increasing environmental awareness and regulatory pressure, water dispensing systems must evolve to support low-impact operation and efficient resource utilization.

Compounding these issues is the lack of redundancy and fail-safe mechanisms in most systems. A single point of failure—such as a clogged filter, depleted additive, or failed pressure sensor—can disable the entire unit until service is performed. Systems lacking modular component separation, bypass logic, or error-tolerant architecture tend to exhibit lower uptime and diminished reliability, especially under continuous use. This lack of resilience can be especially problematic in healthcare, hospitality, and transportation settings where consistent performance is critical.

Given the convergence of these challenges—including hygiene concerns, lack of customization, dosing inconsistencies, poor connectivity, limited deployment flexibility, and inadequate environmental sustainability—there remains an unmet need for a water system that can reliably purify municipal supply, enhance it with tailored nutritional additives, maintain hygienic operation, and deliver precise, temperature-controlled servings in a scalable and intelligent manner. Such a system should combine robust mechanical engineering with advanced sensor networks, remote monitoring capabilities, and modular form factors to support both standalone and integrated use across a wide range of environments.

### SUMMARY OF THE INVENTION

The present invention relates to an integrated system and method for producing, enhancing, and dispensing purified water-based beverages from a municipal supply. The system includes a compact, modular dispensing unit configured to perform multistage water purification, precision dosing of powdered nutritional additives, and automated beverage delivery through a hygienic, touchless interface. The system may include independently controlled additive tanks, automated powder dispensing assemblies, vortex mixing mechanisms, and internal chilling and heating elements to enable customized drink formulation. Additional features include user-recognition functionality via embedded AI cameras, remote monitoring and diagnostics through cellular or Wi-Fi connectivity, and compatibility with flush-mount or freestanding installation in various environments. The system may be implemented in multiple scalable formats—including larger public units and compact residential versions—without requiring major infrastructural changes.

The present invention offers significant advantages over existing water dispensing and enhancement systems. Unlike traditional units that rely on bottled inputs or pre-packaged formulations, this system transforms municipal water into a freshly enhanced beverage with minimal environmental footprint. The use of dry powder dispensing ensures ingredient stability, eliminates the need for preservatives, and reduces servicing requirements. Intelligent sensor arrays and pressure-control mechanisms optimize water quality, safety, and operational continuity, while real-time diagnostics and connectivity features enable remote maintenance and performance oversight. The system's modular design and flexible deployment make it suitable for a wide range of commercial and residential settings, overcoming space, hygiene, and usability limitations seen in the prior art. Moreover, the personalized user interaction capabilities allow for on-demand customization of nutritional profiles, a feature lacking in conventional dispensing platforms.

In a first implementation of the invention, a hydration system is provided for producing a customized beverage from a municipal water supply. The system includes a housing defining an interior volume and a dispensing interface, and a water inlet configured to receive water from a municipal supply line. A purification assembly is disposed within the housing and fluidly coupled to the water inlet, the purification assembly being configured to remove contaminants from the received water. At least one additive reservoir is disposed within the housing and contains a beverage enhancement composition. A mixing chamber is fluidly coupled to the purification assembly and to the at least one additive reservoir, the mixing chamber being configured to receive purified water and the beverage enhancement composition. The system further includes a dispensing outlet fluidly coupled to the mixing chamber and positioned at the dispensing interface. A control unit is disposed within the housing and is configured to control operation of the hydration system, the control unit comprising a processor and memory and being programmed to initiate water flow through the purification assembly, direct the beverage enhancement composition from the additive reservoir into the mixing chamber, and initiate delivery of a resulting beverage through the dispensing outlet.

In another aspect, the purification assembly may comprise a multistage filtration unit including a sediment filter, a carbon pre-filter, a secondary carbon filter, and a polishing filter. In another aspect, the purification assembly may further comprise a UV-C sterilization component configured to expose the water to ultraviolet light.

In another aspect, the beverage enhancement composition may comprise at least one powdered nutritional supplement.

In another aspect, the system may further comprise a powder dispensing assembly disposed between the additive reservoir and the mixing chamber, the powder dispensing assembly being configured to deliver a metered quantity of the powdered nutritional supplement.

In another aspect, the powder dispensing assembly may comprise a rotatable disk having a cavity for receiving a measured amount of the powdered nutritional supplement.

In another aspect, the powder dispensing assembly may further comprise a funnel positioned beneath the rotatable disk and configured to direct the powdered nutritional supplement into the mixing chamber.

In another aspect, the beverage enhancement composition may comprise a liquid electrolyte concentrate.

In another aspect, the system may comprise a peristaltic pump fluidly coupling the electrolyte concentrate to the mixing chamber.

In another aspect, the mixing chamber may comprise a motorized mixing device configured to agitate the contents of the chamber.

In another aspect, the motorized mixing device may comprise a vortex mixer disposed within the mixing chamber.

In another aspect, the system may further comprise a temperature control assembly configured to regulate the temperature of the beverage within the mixing chamber.

In another aspect, the temperature control assembly may comprise a chiller and an inline heating element.

In another aspect, the system may further comprise at least one sensor selected from the group consisting of: a pressure sensor, a temperature sensor, a fluid level sensor, and a flow rate sensor.

In another aspect, the dispensing interface may comprise a touchless user interface.

In another aspect, the control unit may be configured to receive a user-specific beverage selection via wireless communication.

In another aspect, the wireless communication may comprise at least one of NFC, Wi-Fi, or Bluetooth.

In another aspect, the housing may be configured for either freestanding installation or flush-mounted integration within a wall surface.

In another implementation of the present invention, a hydration system may be provided for producing a customized beverage from a municipal water supply. The system may include a housing that defines an interior volume and a dispensing interface. A water inlet may be configured to receive water from a municipal supply line. A purification assembly may be disposed within the housing and may include a sediment filter, a carbon pre-filter, a secondary carbon filter, a polishing filter, and a UV-C sterilization chamber. An electrolyte reservoir may contain a liquid electrolyte concentrate, and a peristaltic pump may be fluidly coupled to the reservoir to deliver the concentrate to a mixing chamber. The system may further include a powder dispensing assembly comprising a powder container, a rotatable dispensing disk, a motor to drive the disk, and a funnel positioned beneath the disk to direct a powdered nutritional supplement into the mixing chamber. The mixing chamber may be fluidly coupled to the purification assembly, the peristaltic pump, and the powder dispensing assembly, and may include a vortex mixer to agitate the components. A temperature control assembly may regulate the beverage temperature and may include a water chiller and an inline heating element. A dispensing outlet may be positioned at the dispensing interface to deliver the final beverage. A touchless user interface may be provided for hygienic interaction. A control unit may be operatively connected to the purification assembly, additive reservoirs, mixing components, and dispensing mechanisms. The control unit may be configured to receive user-specific beverage instructions via NFC communication, direct dosing and mixing operations, regulate temperature, and initiate beverage dispensing in response to the received input.

In another implementation of the present invention, a method may be provided for producing a customized beverage from a municipal water supply using a hydration system. The method may include receiving water from a municipal source at a water inlet and purifying the water through a multistage process that includes sediment filtration, carbon pre-filtration, secondary carbon filtration, polishing filtration, and UV-C sterilization. The method may further include receiving a beverage selection from a user via NFC communication. Based on the user selection, a measured amount of liquid electrolyte concentrate may be delivered from an internal reservoir to a mixing chamber using a peristaltic pump. A metered quantity of powdered nutritional supplement may be dispensed into the mixing chamber using a motorized powder dispensing assembly. The purified water, electrolyte concentrate, and powdered supplement may be combined in the mixing chamber and agitated using a vortex mixer to form a uniform beverage mixture. The temperature of the beverage may then be adjusted using a chiller or inline heater depending on user preference. Finally, the beverage may be dispensed through an outlet in response to the user command.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a front perspective view of an illustrative hydration unit in a closed configuration, showing an external enclosure mounted to a structural wall surface, with the outer drywall layer omitted for clarity. The unit is secured to vertical framing studs using designated mounting holes, and is connected to a rear water supply line and a waste water discharge line routed through the wall cavity;

FIG. 2 presents a front perspective view of the hydration unit illustrated in FIG. 1, shown with the dispensing interface partially open to reveal an internal fluid delivery nozzle positioned within the bezel;

FIG. 3 presents a front elevation view of the hydration unit with the front housing removed, illustrating the internal layout of pumps, tubing, tanks, and electronic components arranged within the vertical chassis beneath the dispensing bezel;

FIG. 4 presents a front elevation view of the internal assembly of the hydration unit, illustrating the flow path and arrangement of major subsystems including the water inlet and shutoff mechanism, pressure sensing and filtration components, an electrolyte supply reservoir, additive pumps and mixing chambers, solenoid valves, sterilization and chilling elements, nutrient dispensers, and output lines for beverage delivery;

FIG. 5 presents a front perspective view of the hydration unit with the outer housing removed, showing the vertical arrangement of internal subsystems including the purification assembly, ingredient storage tanks, additive mixing components, control circuitry, and fluid routing infrastructure;

FIG. 6 presents a side elevation view of an additive dispensing assembly, showing a powder container positioned above a rotating dispensing disk, with an intermediate funnel and a motorized drive assembly for controlled transfer of powder into a receiving tank;

FIG. 7 presents a front elevation view of an illustrative hydration system integrated into a tree-shaped exterior housing, shown in a vertically mounted configuration with connections to a subterranean water supply line and waste water line embedded within a concrete foundation;

FIG. 8 presents a sectional detail view of the foundation structure supporting the hydration system, illustrating the concrete base, embedded rebar support, integrated plumbing tube, and J-bolt anchoring system used to secure the system at ground level; and

FIG. 9 presents a schematic flow diagram of the hydration system, showing the sequence of operational components from user application input and NFC initiation through water purification, ingredient dosing, chilling or heating, volume sensing, and final beverage delivery.

Like reference numerals refer to like parts throughout the several views of the drawings.

### DETAILED DESCRIPTION OF THE PREFERRED EMBODIMENT

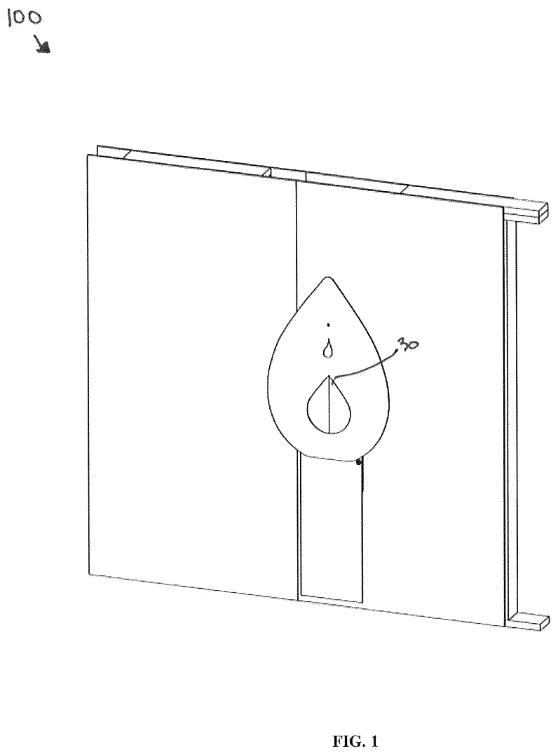

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present disclosure relates to a hydration system 100 configured to produce customized beverages from a municipal water source, incorporating a multistage purification assembly, integrated additive dispensers, a mixing and temperature regulation subsystem, and an intelligent control unit operable via wireless communication. As shown in FIG. 1, the hydration system 100 may be mounted within a wall cavity and secured to vertical studs using a series of mounting structures while being connected to a municipal water supply line and a wastewater discharge line routed through the wall. The housing of the system 100 may define an interior volume containing various filtration, pumping, additive dispensing, and control components. A front bezel may be provided to form a dispensing interface, and the unit may be configured for either flush-mount installation as depicted or for freestanding deployment in alternative configurations. Access to the water inlet 1 is provided from the rear, while filtered beverage output may be delivered through a dispensing outlet located at the front of the housing. The external shell may be composed of molded polymer or powder-coated metal for aesthetic and hygienic purposes. The outer housing may be detachable to allow servicing and inspection of internal components.

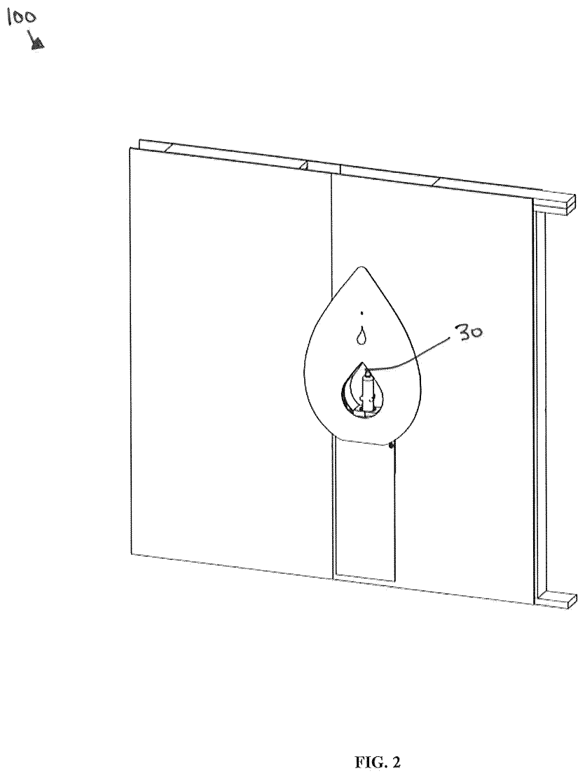

FIG. 2 shows the hydration system 100 with the dispensing interface partially opened to reveal the output nozzle positioned within the front bezel. The nozzle may be configured for downward fluid delivery and may be constructed of food-grade polymeric or stainless steel materials. The bezel surrounding the nozzle may include a transparent or translucent screen to support LED-based status indicators. The dispensing interface may incorporate a proximity-based touchless user interface to initiate beverage formulation and delivery sequences. When activated, the nozzle may be flushed using clean water from the internal supply line to ensure sanitary conditions. Internal drain paths may collect wastewater resulting from cleaning cycles and direct it to a discharge line coupled to the wall-mounted drainage infrastructure. The dispensing outlet 30 may be operably connected to the mixing chamber via a series of solenoid valves 14 and flow-regulating conduits. Above the nozzle region, a camera-based sensor assembly may be embedded to allow user recognition and enable profile-specific customization features if activated through software settings. In some embodiments, the camera-based sensor assembly may incorporate artificial intelligence (AI) capabilities, such as facial recognition algorithms, gesture recognition, or behavioral analytics, to enable dynamic user interaction. The AI camera may utilize embedded or cloud-based machine learning models to identify individual users, detect container placement, or infer beverage preferences based on historical patterns. These features may be used to automatically retrieve stored profiles, adjust additive concentrations, or provide feedback on hydration habits. Below the nozzle, a receptacle platform may be present to support a container or cup during dispensing.

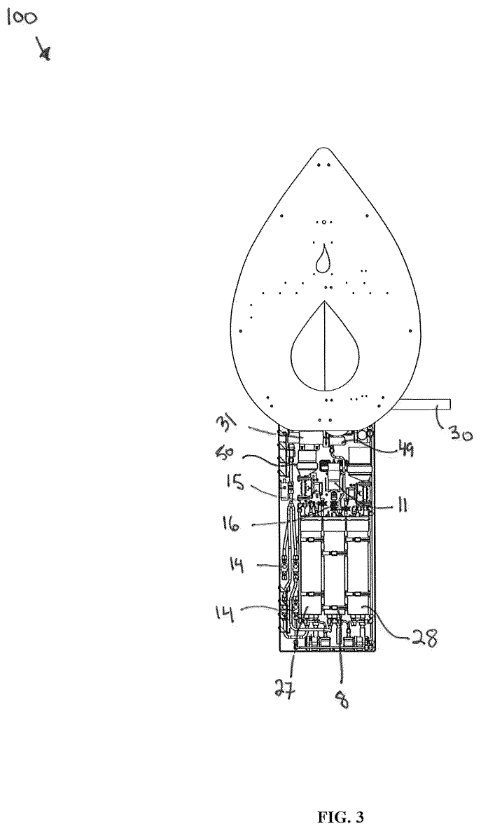

As seen in FIG. 3, the internal structure of the hydration system 100 comprises a vertically aligned chassis containing an array of tanks, pumps, filters, sensors, valves, and control electronics. The incoming municipal water is first directed through the water inlet 1 and flows through a shutoff valve 2, check valve 3, and Y splitter 6. The Y splitter may bifurcate the water flow toward two channels: one toward the electrolyte tank 8 and the other toward the clean water flush path. Flow is regulated by a solenoid valve and water sensor assembly 7 located immediately downstream. A pressure sensor 4 may be placed along the primary inlet path to monitor supply pressure and enable adaptive flow regulation by the control unit 31. The purification assembly comprises a multistage filter assembly 5 that includes a sediment filter, carbon pre-filter, secondary carbon filter, and a polishing filter. After filtration, the water may pass through a UV-C sterilization chamber defined by UV-C lights 21 to deactivate microbial contaminants. From there, purified water is routed to a main water pump 17 and directed to various downstream components including the mixing chamber 34 and chiller assembly 19.

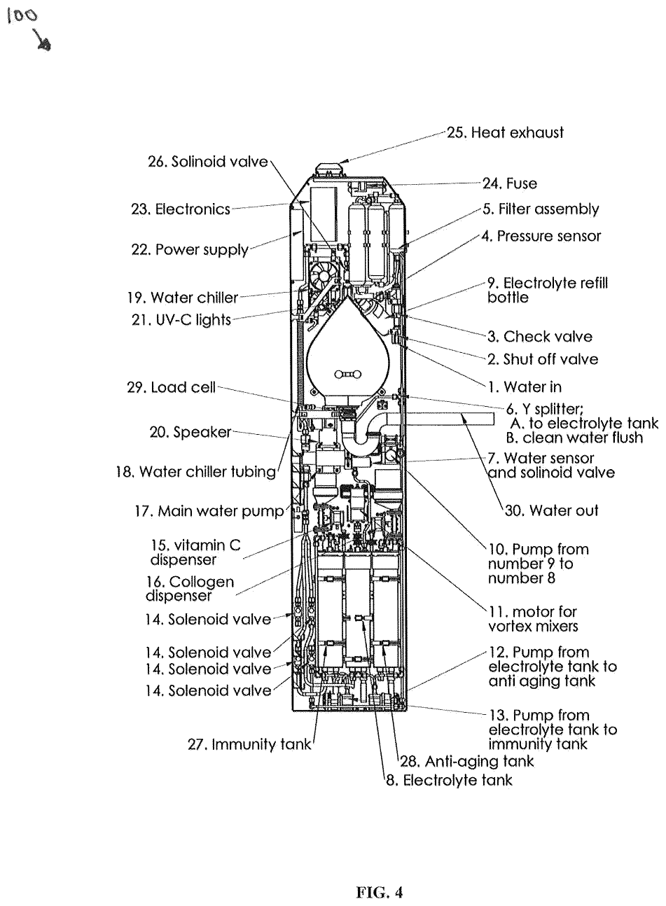

FIG. 4 further illustrates the internal component flow path and demonstrates the interconnection between the purification components, additive delivery tanks, mixing systems, and output lines. The purified water may be selectively combined with additives from multiple reservoirs, including an electrolyte tank 8, immunity tank 27, anti-aging tank 28, vitamin C dispenser 15, and collagen dispenser 16. Each of these reservoirs may store liquid or concentrated compositions configured to enhance the nutritional profile of the resulting beverage. Delivery from these reservoirs to the mixing chamber 34 may be facilitated by a series of peristaltic pumps and solenoid valves 14. For instance, pump 10 may transfer contents from electrolyte refill bottle 9 to the electrolyte tank 8. Pumps 12 and 13 may respectively deliver fluid from the electrolyte tank 8 to the anti-aging tank 28 and immunity tank 27. Flow rates may be dynamically adjusted by the control unit 31 based on sensor feedback, including temperature, pressure, and volume sensed at the load cell 29 and other internal sensors.

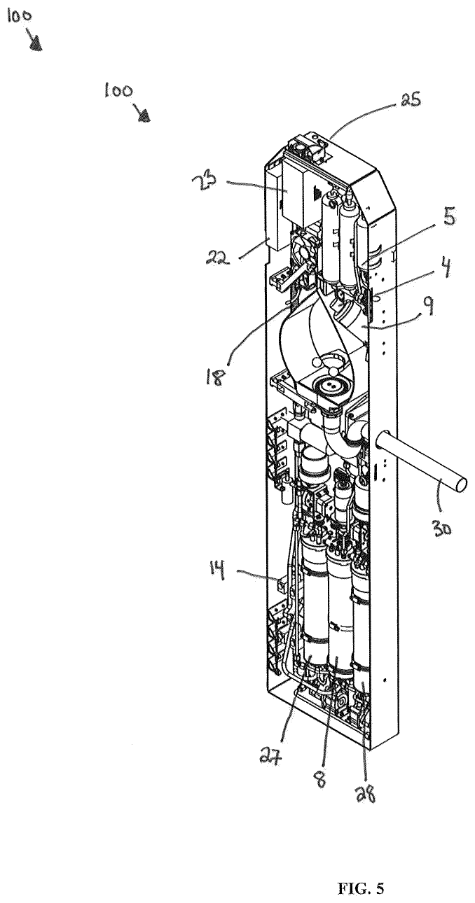

In the configuration shown in FIG. 5, the hydration system 100 may include a vertically arranged mixing chamber 34 that receives both purified water and additive components. The chamber 34 may house a vortex mixer driven by motor 11 for uniform blending of contents. The mixing chamber 34 may also be fluidly coupled to a temperature control assembly that includes a water chiller 19 and associated tubing 18 for cooling operations. An inline heating element 35 may be positioned downstream of the chiller to enable heating cycles. The chiller may be powered by the electronics module 23 and receive control signals from the main control unit 31. Exhaust heat from the cooling subsystem may be vented via heat exhaust port 25. A speaker 20 may emit audio prompts or alerts related to system status or beverage preparation cycles. A fuse 24 and power supply 22 provide overcurrent protection and electrical regulation. Clean water used for nozzle flushing or internal cleaning cycles may be routed through dedicated solenoid valves 14 and directed to the waste discharge line via outlet 30. The electronic subsystem 23 may include firmware to manage user-specific preferences, wireless communication (e.g., via NFC), and self-diagnostic routines.

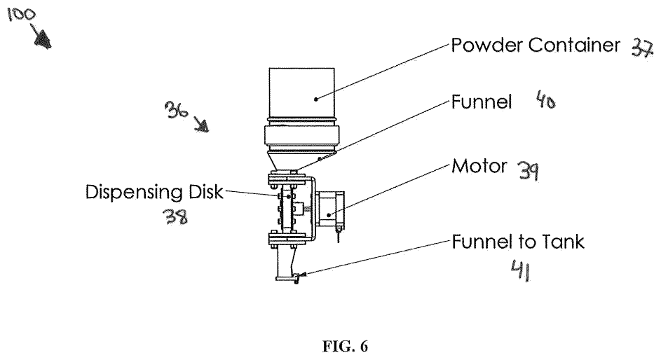

Referring to FIG. 6, the powder dispensing assembly 36 may be mounted within the housing and configured to deliver measured quantities of dry powdered supplements into the mixing chamber 34. The assembly 36 may comprise a powder container 37 positioned above a rotatable dispensing disk 38. The dispensing disk 38 may include multiple cavities formed circumferentially around its axis of rotation, each cavity designed to hold a predetermined dose of powdered additive. A motor 39 may be mechanically coupled to the dispensing disk 38 to drive rotation in response to control signals from the system controller 31. Positioned beneath the dispensing disk 38 is a funnel 40 that directs the powdered material into a funnel-to-tank structure 41 aligned with the mixing chamber inlet. When a dosing operation is initiated, the motor 39 rotates the disk 38, aligning a filled cavity over the funnel 40, thereby allowing gravity-assisted delivery of the powder into the mixing chamber. The powder container 37 may be sealed to prevent moisture ingress and preserve ingredient stability. The entire powder dispensing assembly 36 may be removable or serviceable to allow refilling or maintenance.

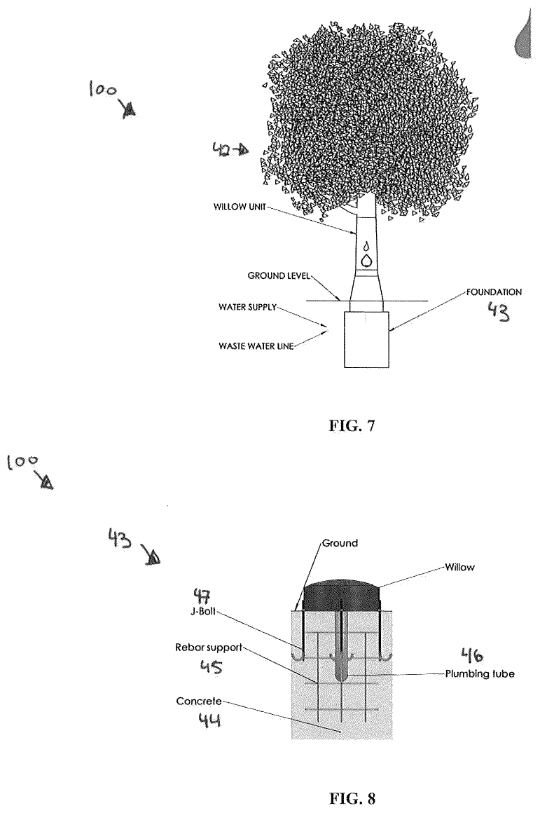

In FIG. 7, the hydration system 100 is depicted as installed in a freestanding outdoor housing designed to resemble a stylized tree. The outer shell 42 may be fabricated from weather-resistant polymer or composite materials and mounted on a base structure using bolts or embedded anchor mechanisms. The base of the structure may be installed above a subterranean water supply line and discharge plumbing, with appropriate insulation or sealing to protect against environmental exposure. The dispensing interface may remain accessible at the upper portion of the structure, with internal fluid routing and electronic components configured similarly to the wall-mounted version. This freestanding embodiment may be suitable for installation in public parks, outdoor plazas, or campus settings where architectural integration is desirable. The aesthetic housing 42 may be designed for tamper resistance and ease of servicing by maintenance personnel.

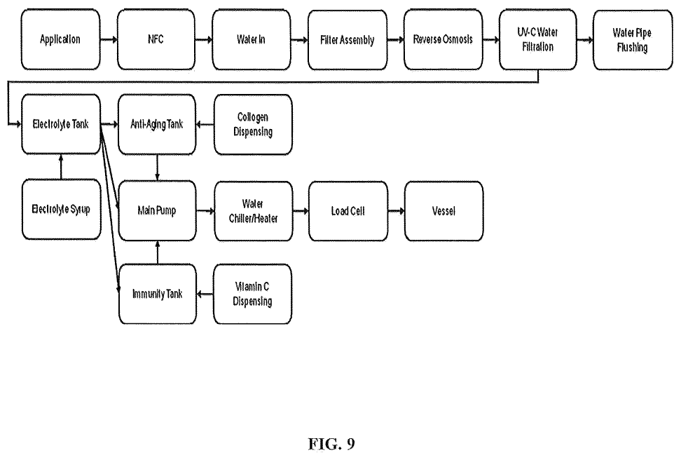

Turning to FIG. 8, a sectional detail view illustrates the foundation structure 43 supporting the freestanding hydration system 100. The system may be mounted atop a reinforced concrete base 44 embedded with rebar supports 45 for mechanical rigidity. A plumbing tube 46 may be cast into the foundation to accommodate the water inlet line and wastewater discharge conduit. The system may be secured to the concrete foundation using J-bolt anchors 47, which may be embedded during the pour and subsequently engaged through base mounting holes. The foundation 43 may be dimensioned to support the full weight of the system, including filled additive reservoirs, under dynamic loading conditions. Waterproof gaskets or seals may be used at all interface junctions to prevent moisture ingress. Electrical and data cables may also be routed through the plumbing tube 46 to connect the system to external power or remote monitoring infrastructure.

In some embodiments, the hydration system may include smart connectivity features configured to interface with external health and wellness platforms. The system may receive dynamic additive dosing instructions or hydration volume recommendations based on biometric or activity data retrieved from connected fitness trackers, mobile health applications, or wearable sensors. The control unit may support cloud synchronization to allow user profiles to persist across different units without manual configuration. A touchscreen display may be incorporated into the dispensing interface to allow user interaction, hydration goal tracking, or real-time formulation adjustments. In some versions, the system may be operable via voice command through integration with home assistant platforms, enabling hands-free operation. Access control features such as child locks, PIN authentication, or NFC-based user verification may be employed to restrict unauthorized dispensing. Environmental sensors may detect ambient conditions such as temperature or humidity, and adjust beverage parameters accordingly to maintain optimal hydration effectiveness.

As shown in the schematic block diagram of FIG. 9, the hydration system 100 may be configured to operate in a sequenced manner beginning with user interaction through a mobile application or embedded NFC module. Upon activation, municipal water is directed through the filtration sequence comprising the filter assembly 5 and UV-C water filtration 21. Following purification, the flow path diverges to various additive tanks including the electrolyte tank 8, anti-aging tank 28, and immunity tank 27, each coupled to the main pump 17. Additives such as collagen from the collagen dispenser 16 and vitamin C from the vitamin C dispenser 15 may be injected into the mixing stream prior to reaching the mixing chamber 34. The mixture may then pass through the water chiller 19 and optionally through the inline heating element 35 depending on user preference. A load cell 29 may be used to verify volume accuracy before final delivery through the dispensing outlet 30. A speaker 20 may provide user feedback, while the control unit 31 regulates the entire process using embedded logic and sensor input.

The control unit 31 may comprise a processor and memory and may be configured to execute multiple firmware routines including beverage profile management, error handling, and real-time monitoring. The unit 31 may also log historical data for servicing analytics and transmit operational status to a cloud-based dashboard via Wi-Fi or cellular modem 48. In alternative embodiments, Bluetooth communication may be supported for local configuration or diagnostics. A secondary controller 49 may handle low-level hardware management, allowing the main control unit 31 to prioritize high-level sequencing and user interaction. Sensors 50 located at strategic positions throughout the system may measure temperature, pressure, fluid level, and flow rate, transmitting the data in real time to the control logic. These sensors enable responsive modulation of pump speeds, valve actuation, and mixer duration. The mixer motor 11 within the mixing chamber 34 may be configured to operate in bursts or continuous mode depending on the viscosity and ingredient profile of the beverage.

The system 100 may optionally support remote firmware updates and over-the-air configuration using encrypted communication protocols. A modular hardware architecture May permit different configurations for commercial and residential deployments. For example, a compact version of the powder dispensing assembly 36 may be implemented in countertop models with smaller powder containers 37 and simplified motor drive systems. In high-volume commercial models, multiple additive tanks and duplicate chiller systems may be included for redundancy. The control unit 31 may support multiple user profiles and assign beverage formulas based on NFC-enabled user ID cards, facial recognition, or mobile application pairing. Dispensing metrics may be stored locally or on cloud servers, and the system may be configured to lock dispensing during unauthorized access attempts. Maintenance alerts may be generated based on sensor data trends or operational thresholds, prompting service calls or filter replacement.

The beverage enhancement compositions stored in the additive tanks may include electrolyte solutions, plant-based extracts, vitamins, amino acids, or flavoring agents in either liquid or dry powder form. The powder dispensing assembly 36 enables precise metering of dry ingredients without contamination or moisture exposure. Doses may be adjusted dynamically based on user selection, age, health status, or activity level, as determined by logic rules embedded in the control firmware. The vortex mixer 34 enables homogeneous blending of powder, liquid additives, and purified water even under variable flow conditions. The chiller assembly 19 may incorporate Peltier elements or refrigeration coils, while the inline heating element 35 may use resistive heating for rapid temperature adjustment. Beverage delivery may occur once the load cell 29 verifies the target volume and mixing parameters are met. The dispensing nozzle may be automatically flushed with clean water between sessions to maintain hygiene.

The method of using the hydration system 100 to prepare a customized nutrient-enhanced beverage may be understood with reference to FIG. 9, which illustrates the operational flow from initial activation to final dispensing. In a typical implementation, the method begins when a user initiates a request through a connected mobile application or by interfacing directly with the onboard near-field communication (NFC) module. The system 100 receives the user input and retrieves corresponding beverage formulation parameters, which may be stored locally or in a cloud-based profile. These parameters may define additive selection, target temperature, volume, and other mixing preferences. Upon confirmation, the system 100 activates a processing sequence governed by an embedded control unit 31, which orchestrates flow regulation, additive delivery, and mixing operations in accordance with the selected formulation.

Once initiated, municipal water is drawn into the system 100 via the water inlet 1 and routed through a shutoff valve 2 and check valve 3. The water is then split at Y-splitter 6, with the primary path directed toward the internal purification assembly. The filtration process includes passage through filter assembly 5, which removes particulates and chemical contaminants. The filtered water is then sterilized using UV-C lights 21 to ensure microbiological safety. Purified water is pumped by the main pump 17 through downstream paths including the mixing chamber and temperature conditioning subsystems. Concurrently, selected additives—such as electrolyte solution from the electrolyte tank 8, immune-support ingredients from immunity tank 27, and anti-aging compounds from tank 28—are metered via respective pumps (e.g., pumps 12 and 13) and introduced into the main flow path under the control of solenoid valves 14. The vitamin C dispenser 15 and collagen dispenser 16 may also be actuated to deliver precise doses into the mixture based on the user's preferences or health profile.

As water and additives converge within the mixing chamber, the motor-driven vortex mixer 11 activates to homogenize the contents. The mixture may then pass through the water chiller 19 and, if needed, an inline heater 35 to achieve the desired temperature. A load cell 29 situated beneath the mixing chamber monitors fluid volume and weight to ensure dosing accuracy. Once the target volume and consistency are achieved, the control unit 31 actuates the dispensing solenoid valve 14 associated with the outlet 30, delivering the beverage into a user's receptacle. Following dispensing, the system may initiate an automatic cleaning cycle by flushing residual contents through a clean water path via the Y-splitter 6 and associated solenoid valves. Wastewater is directed to a drain line connected at the base of the unit. The method may further include logging session data and transmitting it via a wireless module to a backend server or analytics platform.

Through this method, the system 100 enables precise, reproducible preparation of customized beverages enhanced with various nutritional, functional, and cosmetic ingredients. The modular delivery structure and intelligent control architecture support personalization, sanitation, and regulatory compliance, while maintaining operational efficiency suitable for both residential and commercial deployment.

In alternate embodiments, the hydration system 100 may be implemented in various structural and functional configurations to accommodate different use environments, scalability requirements, and user preferences. For instance, while the figures illustrate a vertically mounted unit suitable for flush installation within a wall cavity (see FIG. 1 and FIG. 7), alternate embodiments may feature a freestanding kiosk-style housing for placement in high-traffic public venues such as gyms, airports, or shopping centers. In such embodiments, the housing may incorporate a reinforced base with integrated ballast or anchoring mechanisms to provide stability. The dispensing interface may be positioned at varying heights or include adjustable nozzles to accommodate users of different statures, including children and individuals in wheelchairs. The user interface may also be modified to include larger screens or additional tactile buttons for environments where touchless operation may be impractical.

In another variation, the additive delivery subsystems may be reconfigured to support different enhancement formats. While the illustrated embodiment employs a powder dispensing assembly (see FIG. 6) and liquid additive tanks (e.g., electrolyte tank 8, immunity tank 27, anti-aging tank 28), alternate embodiments may utilize preloaded additive cartridges, single-use ampoules, or concentrated gel packs. These alternative formats may simplify maintenance and reduce cross-contamination risk, especially in clinical or pharmaceutical-grade installations. The powder dispensing mechanism may also be replaced with a volumetric auger, piston-driven capsule feeder, or gravity-fed dosage chute, depending on ingredient form factor and reconstitution requirements. The mixing chamber may incorporate an ultrasonic agitator or magnetic stir bar in lieu of the vortex mixer 11 to accommodate shear-sensitive components or viscous formulations.

Further embodiments may feature a reduced number of additives and subsystems to support low-cost or compact variants for residential use. In such configurations, the system may eliminate components like the load cell 29, multiple solenoid valves 14, and temperature control elements to conserve space and reduce power consumption. The UV-C sterilization component 21 may be substituted with an activated carbon or nano-filtration stage in markets where UV regulation or availability is limited. Additionally, the control unit 31 may operate on a simplified microcontroller platform without wireless connectivity, instead utilizing manual dials or analog input switches. Such streamlined versions may be embedded into kitchen appliances or integrated within refrigerator doors, using direct plumbing connections for water supply and modular refill cartridges for additives.

Alternate embodiments may also incorporate advanced sensing and personalization features. In premium configurations, the system 100 may include biometric identification such as facial recognition or fingerprint scanning to retrieve individual user profiles stored in a secure onboard memory or cloud-based account. The user interface may display dynamic nutritional analytics and allow for real-time modifications to beverage composition. The dispensing assembly may include an auto-sealing lid mechanism to facilitate hygienic grab-and-go containerization. In smart home environments, the system may interface with centralized voice assistants or smart refrigerators to sync hydration schedules, track ingredient depletion, and schedule maintenance reminders. The modular nature of the components allows such enhancements to be introduced without altering the fundamental fluidic architecture or dispensing method.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A hydration system for producing a customized beverage from a municipal water supply, the system comprising:
an elongated body comprising a first housing half and a second housing half, each having a longitudinal length and a tapered leading end configured for insertion through the structural opening;
a housing defining an interior volume and a dispensing interface;
a water inlet configured to receive water from a municipal supply line;
a purification assembly disposed within the housing and fluidly coupled to the water inlet, the purification assembly being configured to remove contaminants from the received water;
at least one additive reservoir disposed within the housing and containing a beverage enhancement composition;
a mixing chamber fluidly coupled to the purification assembly and to the at least one additive reservoir, the mixing chamber configured to receive purified water and the beverage enhancement composition;
a dispensing outlet fluidly coupled to the mixing chamber and positioned at the dispensing interface; and
a control unit disposed within the housing and configured to control operation of the hydration system, the control unit comprising a processor and memory, and being programmed to:
initiate water flow through the purification assembly,
direct the beverage enhancement composition from the at least one additive reservoir into the mixing chamber, and
initiate delivery of a resulting beverage through the dispensing outlet.

2. The hydration system of claim 1, wherein the purification assembly comprises a multistage filtration unit including a sediment filter, a carbon pre-filter, a secondary carbon filter, and a polishing filter.

3. The hydration system of claim 2, wherein the purification assembly further comprises a UV-C sterilization component configured to expose the water to ultraviolet light.

4. The hydration system of claim 1, wherein the beverage enhancement composition comprises at least one powdered nutritional supplement.

5. The hydration system of claim 4, further comprising a powder dispensing assembly disposed between the at least one additive reservoir and the mixing chamber, the powder dispensing assembly comprising a motor-driven dispensing mechanism configured to deliver a metered quantity of the powdered nutritional supplement.

6. The hydration system of claim 5, wherein the powder dispensing assembly comprises a rotatable disk having a cavity for receiving a measured amount of the powdered nutritional supplement.

7. The hydration system of claim 6, wherein the powder dispensing assembly further comprises a funnel positioned beneath the rotatable disk and configured to direct the powdered nutritional supplement into the mixing chamber.

8. The hydration system of claim 1, wherein the beverage enhancement composition comprises a liquid electrolyte concentrate.

9. The hydration system of claim 8, wherein the system comprises a peristaltic pump fluidly coupling the electrolyte concentrate to the mixing chamber.

10. The hydration system of claim 1, wherein the mixing chamber comprises a motorized mixing device configured to agitate the contents of the chamber.

11. The hydration system of claim 10, wherein the motorized mixing device comprises a vortex mixer disposed within the mixing chamber.

12. The hydration system of claim 1, further comprising a temperature control assembly configured to regulate the temperature of the beverage within the mixing chamber.

13. The hydration system of claim 12, wherein the temperature control assembly comprises a chiller and an inline heating element.

14. The hydration system of claim 1, further comprising at least one sensor selected from the group consisting of: a pressure sensor, a temperature sensor, a fluid level sensor, and a flow rate sensor.

15. The hydration system of claim 1, wherein the dispensing interface comprises a touchless user interface.

16. The hydration system of claim 1, wherein the control unit is configured to receive a user-specific beverage selection via wireless communication.

17. The hydration system of claim 16, wherein the wireless communication comprises at least one of NFC, Wi-Fi, or Bluetooth.

18. The hydration system of claim 1, wherein the housing is configured for either freestanding installation or flush-mounted integration within a wall surface.

19. A hydration system for producing a customized beverage from a municipal water supply, the system comprising:
a housing defining an interior volume and a dispensing interface;
a water inlet configured to receive water from a municipal supply line;
a purification assembly disposed within the housing and fluidly coupled to the water inlet, the purification assembly comprising a sediment filter, a carbon pre-filter, a secondary carbon filter, a polishing filter, and a UV-C sterilization chamber;
an electrolyte reservoir disposed within the housing and containing a liquid electrolyte concentrate;
a peristaltic pump fluidly coupled to the electrolyte reservoir and configured to deliver the liquid electrolyte concentrate to a mixing chamber;
a powder dispensing assembly disposed within the housing and comprising:
a powder container configured to hold a powdered nutritional supplement,
a rotatable dispensing disk configured to receive and meter a quantity of the powdered nutritional supplement,
a motor operatively connected to the dispensing disk, and
a funnel disposed beneath the dispensing disk and configured to direct the powdered nutritional supplement into the mixing chamber;
a mixing chamber fluidly coupled to the purification assembly, the peristaltic pump, and the funnel, the mixing chamber comprising a vortex mixer configured to agitate the purified water, the liquid electrolyte concentrate, and the powdered nutritional supplement;
a temperature control assembly comprising a water chiller and an inline heating element configured to regulate the temperature of the contents of the mixing chamber;
a dispensing outlet fluidly coupled to the mixing chamber and positioned at the dispensing interface;
a touchless user interface disposed on the housing; and
a control unit operatively connected to the purification assembly, the peristaltic pump, the powder dispensing assembly, the mixing chamber, the temperature control assembly, and the dispensing outlet, the control unit comprising a processor and memory and being configured to:
receive a user-specific beverage selection via NFC communication;
control the delivery of purified water, liquid electrolyte concentrate, and the powdered nutritional supplement into the mixing chamber based on the beverage selection;
operate the vortex mixer to produce a homogenous beverage;
adjust the temperature of the beverage using the temperature control assembly; and
initiate dispensing of the beverage through the dispensing outlet.

20. A method for producing a customized beverage from a municipal water supply using a hydration system, the method comprising:
receiving, at a housing-mounted water inlet, water from a municipal supply line;
purifying the received water using a purification assembly comprising at least a sediment filter, a carbon pre-filter, a secondary carbon filter, a polishing filter, and a UV-C sterilization chamber;
receiving, at a control unit, a user-specific beverage selection input via near-field communication (NFC);
delivering a metered volume of a liquid electrolyte concentrate from an electrolyte reservoir into a mixing chamber using a peristaltic pump;
dispensing a measured quantity of a powdered nutritional supplement into the mixing chamber using a powder dispensing assembly comprising a rotatable dispensing disk, a powder container, a motor, and a funnel;
combining the purified water, the liquid electrolyte concentrate, and the powdered nutritional supplement within the mixing chamber;
mixing the contents of the mixing chamber using a vortex mixer to form a homogenous beverage;
regulating the temperature of the beverage using a temperature control assembly comprising a water chiller and an inline heating element; and
dispensing the temperature-regulated beverage through a dispensing outlet in response to the user-specific beverage selection.
